(19) United States
(12) Patent Application Publication
(10) Pub. No.: US 2006/0024128 A1
(43) Pub. Date: Feb. 2, 2006

(54) Multidirectional joint connector

(76) Inventor: I - Cheng Chiu, Taipei (TW)

Correspondence Address: Keith Kline;PRO-TECHTOR INTERNATIONAL SERVICES, 20775 Norada Court, Saratoga, CA, 95070-3018, US

(21) Appl. No.: 10/900,672

(22) Filed: Jul. 27, 2004

(51) Int. Cl. F16B 1/00

(52) U.S. Cl. 403/217

(57) ABSTRACT

A multidirectional joint connector, utilizing mutual rabbeting of structural members including a cylindrical main joint connector, a single tube joint connector, a double tube joint connector, a plurality of triangular connecting blocks, a circular joint connector box and a screw, whereafter connecting of straight tubes of a frame to form a strong and endurable combinatorial structural frame can be realized. Furthermore, model of the combinatorial frame so constructed can be modified according to how a user assembles the combinatorial frame and from various directional rabbet joints

### BACKGROUND OF THE INVENTION

(a) Field of the Invention

The present invention relates to a joint connector for a combinatorial frame, which can realize extremely firm assembly of combinatorial structures of various forms, including climbing frames, display racks, showcases, and so on.

(b) Description of the Prior Art

Majority of conventional frames are constructed by joining together wooden blocks with rabbet joints. Structural members of diverse direction are assembled by necessarily utilizing different joint connectors, and thus various molds are necessary to provide for the different joint connectors of diverse configuration, which apart from increasing costs, such assembled frames are also relatively unstable. Moreover, models of frames assembled by means of rabbet joints are incondite and of limited diversification.

### SUMMARY OF THE INVENTION

A primary objective of the present invention is to realize fabricating a frame from a combinatory arrangement of multidirectional joint connectors comprising a main joint connector, a single tube joint connector, a double tube joint connector, connecting blocks, a joint connector box and a screw that enables outwardly continuously extending connectivity in diverse directions therewith, and which provides the frame so assembled with considerable strength, endurance, and rich diversification.

Combinatorial frames, which can be constructed utilizing the present invention, include climbing frames, display racks, and so on.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exterior structural view according to the present invention.

FIG. 2 shows an exploded view according to the present invention.

FIG. 3 shows another exterior view according to the present invention.

FIG. 4 shows a yet another exterior view according to the present invention.

FIG. 5 shows a top view according to the present invention.

FIG. 6 shows a schematic view of an embodiment according to the present invention.

FIG. 7 shows another schematic view of an embodiment according to the present invention.

### DETAILED DESCRIPTION OF THE PREFERRED EMBODIMENTS

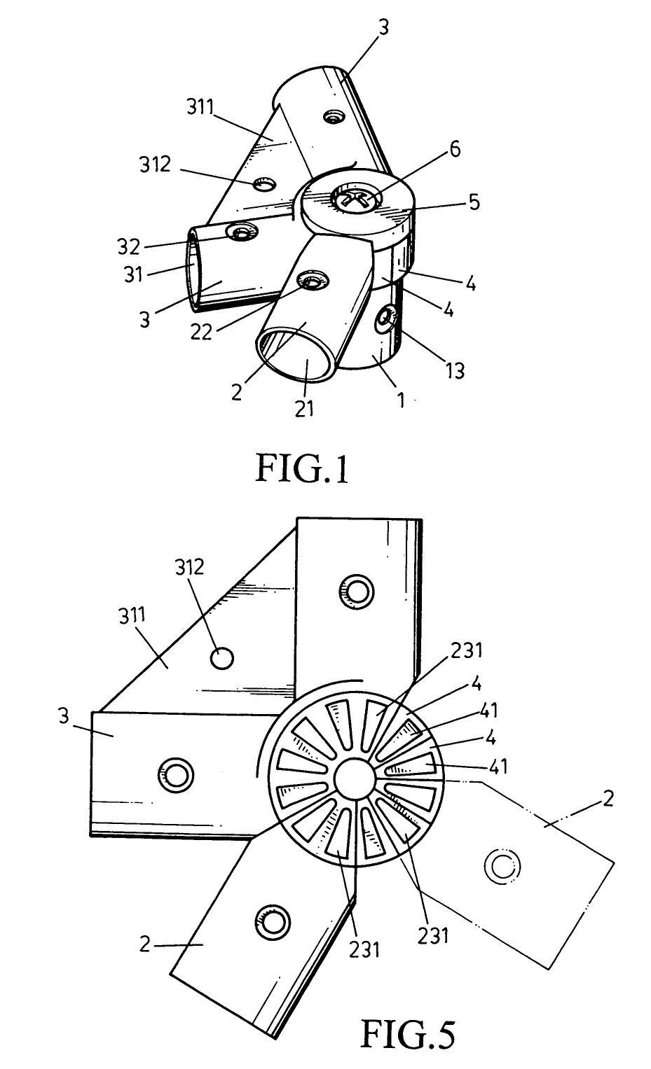

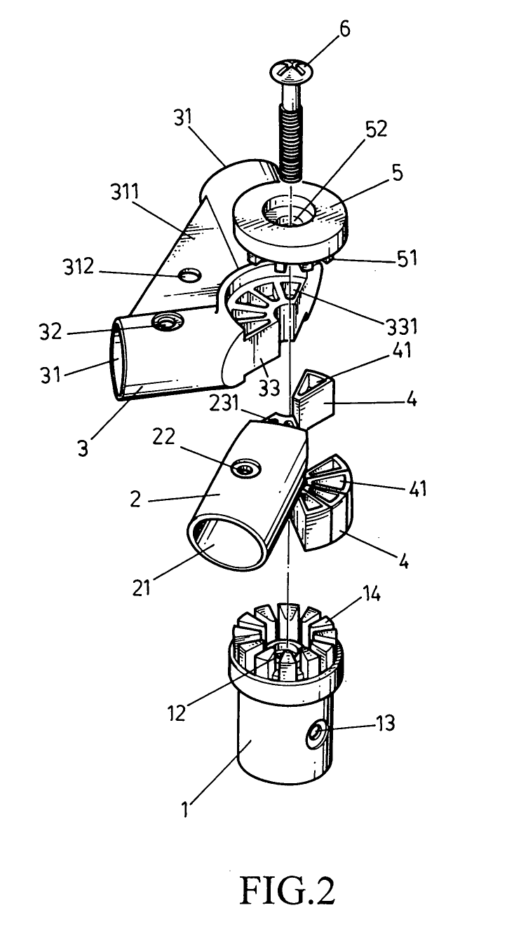

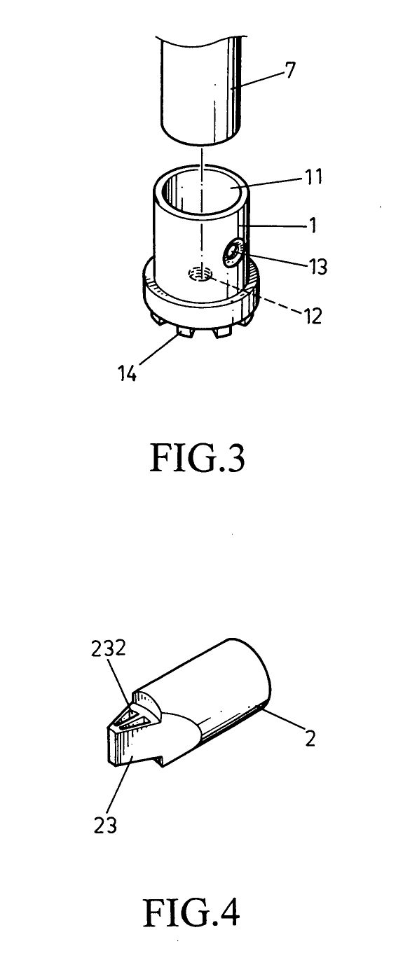

Referring to FIGS. 1 to 5, which show the present invention configured from structural members comprising a main joint connector 1, a single tube joint connector 2, a double tube joint connector 3, a plurality of connecting blocks 4, a joint connector box 5 and a screw 6. The main joint connector 1 assumes a cylindrical form. A base sleeve 11 can couple with a straight tube 7 of a climbing frame (see FIG. 3). A center of the sleeve 11 is provided with a screw hole 12, and a side of the sleeve 11 is provided with a perforation 13. A plurality of (12) triangular quads 14 are configured and circumferentially arranged on a top portion of the main joint connector 1.

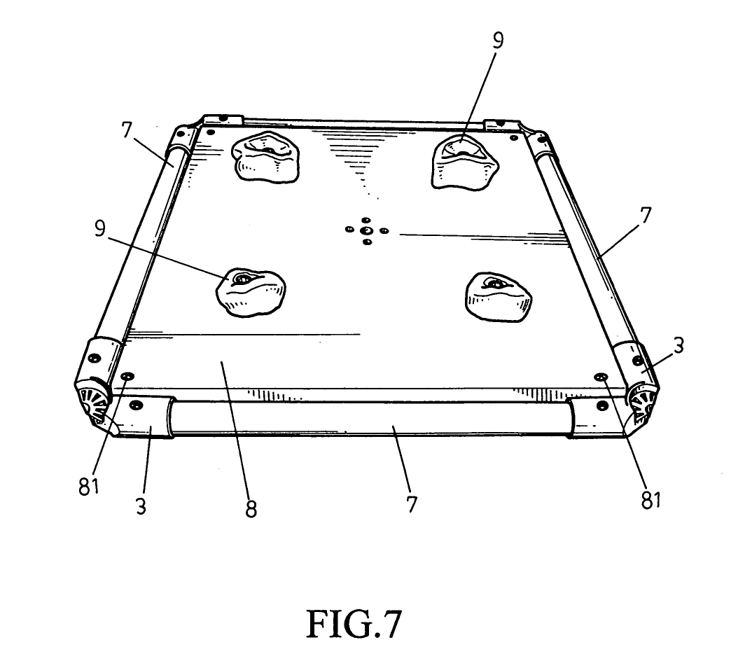

One extremity of the single tube joint connector 2 is provided with a sleeve 21, which can couple with the straight tube 7 of the climbing frame. A side of the sleeve 21 is provided with a perforation 22, and a frontal edge is provided with a fan-shaped lug 23. Two triangular grooves 231, 232 are defined in an upper and lower end of the lug 23 respectively (see FIG. 4). Two of the quads 14 of the main joint connector can thus embed within the two grooves 232 of the lower end of the single tube joint connector 2, thereby joining together the main joint connector 1 and the single tube joint connector 2 and fixing position thereof. Referring to FIG. 7, which shows a large board (for instance, a climbing board) 8 securely fixed atop connecting pieces 311 of four double tube joint connectors 3, and which utilizes bolts 81 to penetrate the board 8 and bolt down into perforations 312 of the connecting pieces 311 of the double tube joint connectors 3, thereby fixing position thereof Blocks 9, such as climbing blocks, and so on, can be further fixedly configured atop the board 8, wherewith can provide even greater diversified usage.

The double tube joint connector 3 is provided with two sleeves 31, between which is the connecting piece 311, and which mutually connects the two sleeves 31 therewith. The connecting piece 311 is provided with the perforation 312. A side of each of the sleeves 31 is further separately provided with a perforation 32. An inwardly facing side of the two sleeves 31 assumes form of an arc-shaped piece 33. A plurality of (five) triangular grooves 331 are separately configured in an upper and lower end of the arc-shaped piece 33 respectively. The quads 14 of the main joint connector can thus embed within the grooves 331 of the lower end of the double tube joint connector 3, thereby joining together the main joint connector 1 and the double tube joint connector 3 and fixing position thereof.

The twelve quads 14 atop the main joint connector 1 separately provide for joining together the single tube joint connector 2 and the double tube joint connector 3 by means of rabbeting, and the remaining quads that have not yet been embedded within a groove provide for successively embedding within each triangular groove 41 of each of the single triangular connecting blocks 4, thereby filling and forming a circular cavity provided with 12 triangular grooves 231, 331 and 41 (see FIG. 5). The circular cavity can thus provide for covering with the circular joint connector box 5, whereby a bottom of the joint connector box 5 is provided with a plurality of (12) circumferentially arranged triangular quads 51, which can separately imbed and fixedly position within the grooves 231, 331 and 41 thereof. Center of the joint connector box 5 is provided with a screw hole 52, which allows for the screw 6 to penetrate and then be screwed down and fixedly positioned within the screw hole 12 of the main joint connector 1.

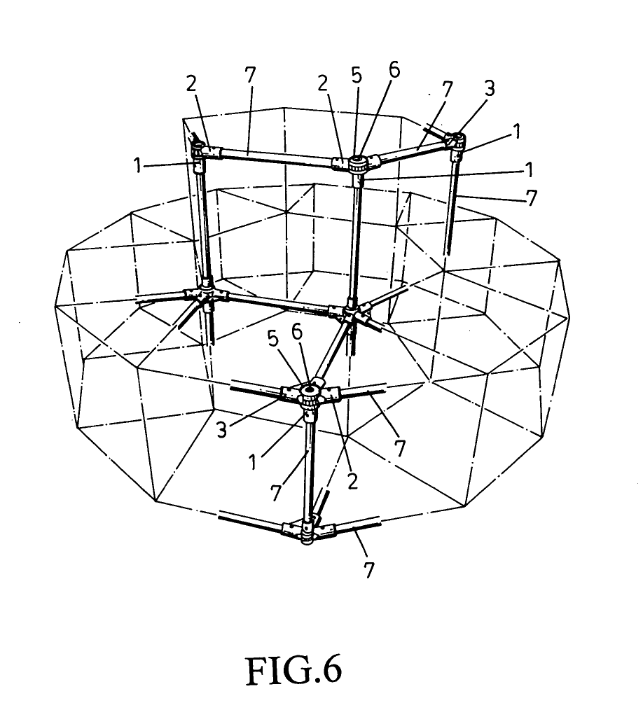

The aforementioned configuration embodies the basic structural members of the present invention, and utilizing the structural members so configured realizes freely combining and assemblage to form connecting directions having two sleeves, eight sleeves, and so on, thus providing the straight tube 7 of the climbing frame to be fabricated in a multitude of directions, including upward/downward, leftward/rightward, frontward/rearward, oppositely diagonal angled directions, and so on, therewith forming a strong and enduring climbing frame assemblage, as depicted in FIG. 6.

In conclusion, the present invention realizes fabricating the climbing frame from a combinatory arrangement of multidirectional joint connectors comprising the main joint connector 1, the single tube joint connector 2, the double tube joint connector 3, the plurality of connecting blocks 4, Furthermore, model of the climbing frame so assembled utilizing the present invention can be modified according to inventiveness of a user, and the multidirectional joint connectors ensure the frame is provided with considerable strength and endurance, moreover, is extremely safe.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A multidirectional joint connector, comprising:
a main joint connector, a base sleeve of which can couple with a straight tube of a climbing frame, a center of the sleeve is provided with a screw hole, and a side of the sleeve is provided with a perforation, a plurality of quads are configured and circumferentially arranged on a top portion of the main joint connector;
a single tube joint connector, one extremity of which is provided with a sleeve, which can couple with a straight tube of a climbing frame, a side of the sleeve is provided with a perforation, and a frontal edge is provided with a fan-shaped lug, two triangular grooves are defined in an upper and lower end of the lug respectively, two quads of the main joint connector can thus embed within the two grooves of the lower end of the single tube joint connector;
a double tube joint connector, which is provided with two sleeves, between which is a connecting piece, and which mutually connects the two sleeves therewith, the two sleeves can couple with straight tubes of a climbing frame, a side of each of the sleeves is further separately provided with a perforation, a plurality of grooves are separately configured in an upper and lower end of an arc-shaped piece of an inwardly facing side of the two sleeves, the quads of the main joint connector can thus embed within the grooves of the lower end of the double tube joint connector;
a plurality of connecting blocks, each of which is provided with a groove, and the connecting blocks utilize the grooves to separately sheathe onto the quads of the main joint connector;
a joint connector box, a bottom of which is provided with a plurality of circumferentially arranged quads, center of the joint connector box is provided with a screw hole, and the quads can separately imbed within the grooves of the single tube joint connector, double tube joint connector and the connecting blocks;
a screw 6, which can penetrate the screw hole of the joint connector box, and thus be screwed down and fixedly positioned within the screw hole of the main joint connector;
aforementioned structural members separately connect straight tubes of a frame, and realize assemblage of straight tubes in a multitude of directions, including upward/downward, leftward/rightward, frontward/rearward, oppositely diagonal angled directions, and so on.

2. The multidirectional joint connector according to claim 1, wherein the quads of the main joint connector, the grooves defined in the lug of the single tube joint connector, the grooves defined in the arc-shaped piece of the double tube joint connector, the grooves defined in the connecting blocks and the quads of the bottom of the joint connector box all assume a triangular form.

3. The multidirectional joint connector according to claim 1, wherein a perforation defined in the connecting piece of the double tube joint connector is utilized to bolt down a board placed atop the connecting piece by means of a bolt therewith.
